(19) United States
(12) Patent Application Publication
(10) Pub. No.: US 2024/0430251 A1
(43) Pub. Date: Dec. 26, 2024

(54) TEMPORARY ACCESS TO A RESOURCE AT EDGE SCENARIOS

(71) Applicant: INTERNATIONAL BUSINESS MACHINES CORPORATION, ARMONK, NY (US)

(72) Inventors: Priyansh Jaiswal, Boca Raton, FL (US); Paul Llamas Virgen, Guadalajara (MX); Peeyush Jaiswal, Boca Raton, FL (US)

(21) Appl. No.: 18/339,251

(22) Filed: Jun. 22, 2023

(51) Int. Cl. H04L 9/40

(52) U.S. Cl. CPC H04L 63/083; H04L 63/108

(57) ABSTRACT

Described is a method of generating a temporary access code to access a resource by a client device presently not authorized to access the resource, while an authorized user device is currently accessing the resource through a connection to a local network to which the client device is also connected. The method can receive a request from the user device to provide the client device access to the resource and generate a temporary access code to access the resource. The method can also receive a scanned temporary access code from the client device and determine whether the scanned temporary access code matches the generated temporary access code for the resource. In the event the scanned temporary access code matches the generated temporary access code for the resource, the method can grant the client device access to the resource associated with the generated temporary access code.

### BACKGROUND

This disclosure relates generally to temporary access to a resource, and in particular to providing temporary access to a resource when located onsite at edge scenarios.

Resource access management is the ability to share limited access to a specific resource to ensure security integrity is maintained by preventing unauthorized access while efficiently handling authorized access. Resource access management further includes tracking and monitoring of resource usage to identify scenarios when access is to be authorized, temporarily authorized, and revoked. For large organizations that include various types of employees and clients, resource access management requires additional focus and scrutiny since a client visiting an organization may require access to a specific resource that would require prior approvals through proper organizational channels. Furthermore, in certain situations rapid access to the specific resource by the client can ensure issues with the resources are addressed sooner, thus mitigating any potential losses due to a delay in accessing the specific resource by the client.

### SUMMARY

Embodiments in accordance with the present invention disclose a method, computer program product and computer system for providing temporary access to a resource when located onsite at edge scenarios, the method, computer program product and computer system can generate a temporary access code to access a resource. The method, computer program product and computer system can determine a client device is connected to a local network, wherein a user device is authorized to access the resource and is in a current session actively accessing the resource on the local network. The method, computer program product and computer system can receive, from the client device, a scanned temporary access code. The method, computer program product and computer system can, responsive to determining the scanned temporary access code matches the temporary access code to access the resource, grant the client device access to the resource.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 depicts a process flow of a temporary access program granting access to various resources to two client devices, in accordance with an embodiment of the present invention.

FIG. 3 depicts a flowchart of a temporary access program granting access to a specific resource utilizing a temporary access code, in accordance with an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments. It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention provide a method of generating a temporary access code to access a resource by a client device presently not authorized to access the resource, while an authorized user device is currently accessing the resource through a connection to a local network to which the client device is also connected. Embodiments of the present invention receive a request from the user device to provide the client device access to the resource and generate a temporary access code to access the resource. Embodiments of the present invention determine the client device is connected to the local network to which the user device is also connected and displays the generated temporary access code in a user interface on the user device for the client to scan with the client device. Embodiments of the present invention receives a scanned temporary access code from the client device and determines whether the scanned temporary access code matches the generated temporary access code for the resource. In the event the scanned temporary access code matches the generated temporary access code for the resource, embodiments of the present invention grant the client device access to the resource associated with the generated temporary access code as long as the client device remains connected to the local network to which the user device is also connect and as long as a predetermined amount of time has not been reached for the temporary access. In the event the client device is no longer connected to the local network, or the predetermined amount of time has been reached, embodiments of the present invention terminate the client device's access to the resource.

It is to be noted that embodiments of the present invention provide various technological improvements in the area of resource access management, specifically in providing rapid temporary accessibility to a resource for onsite clients at edge scenarios. Embodiments of the present invention provide secure temporary remote access for a client device that is not authorized to access a resource by extending remote access to a current session of the user device actively accessing the resources on the same local network to which the client device is also connected. Embodiments of the present invention also provide improvements to the trackability of temporary access requests and which client devices have accessed which resources.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

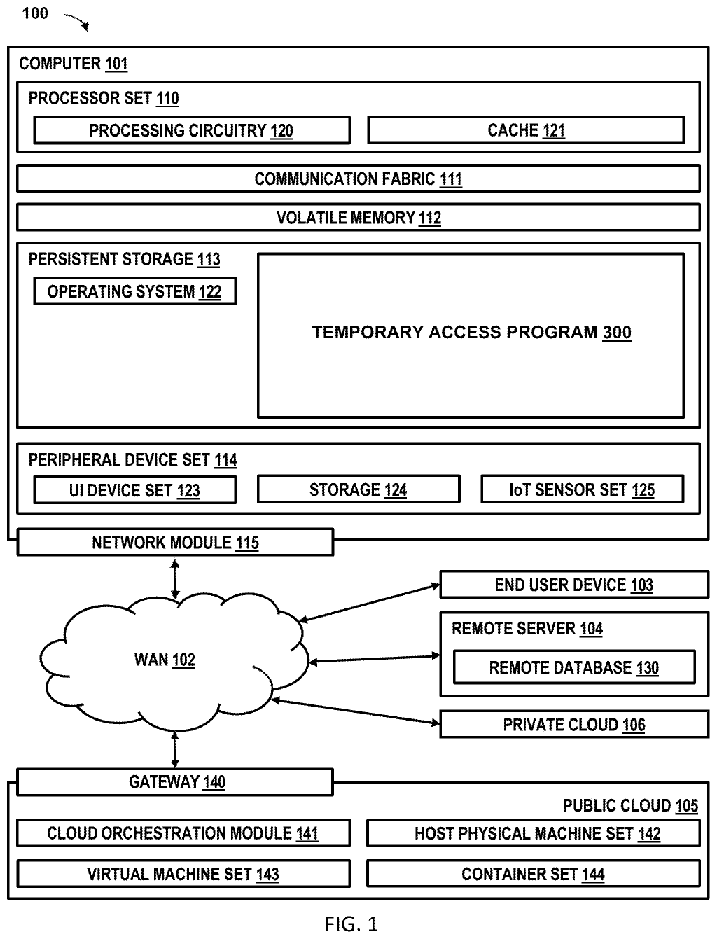

FIG. 1 is a functional block diagram illustrating a computing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

Computing environment 100 contains an example of an environment for the execution of at least some of the computer code involved in performing the inventive methods, such as, temporary access program 300. In addition to block 300, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 300, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 300 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 300 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

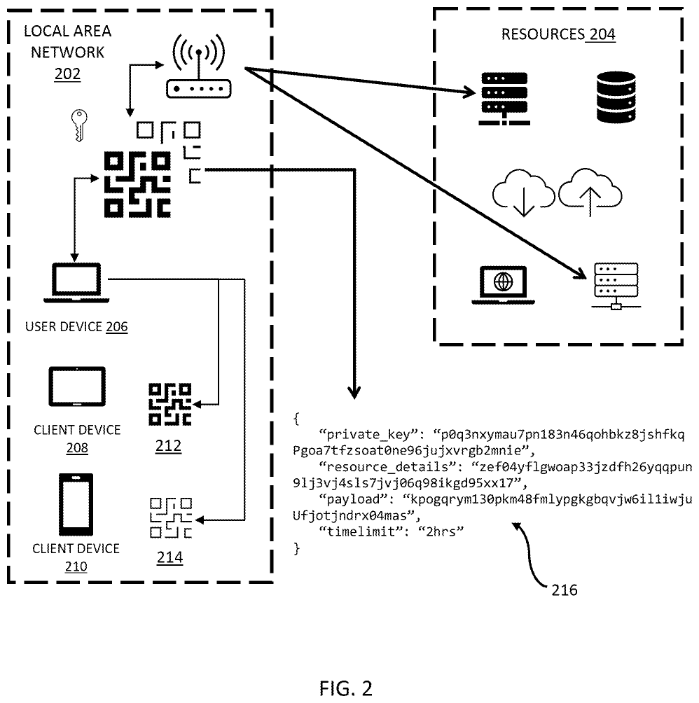

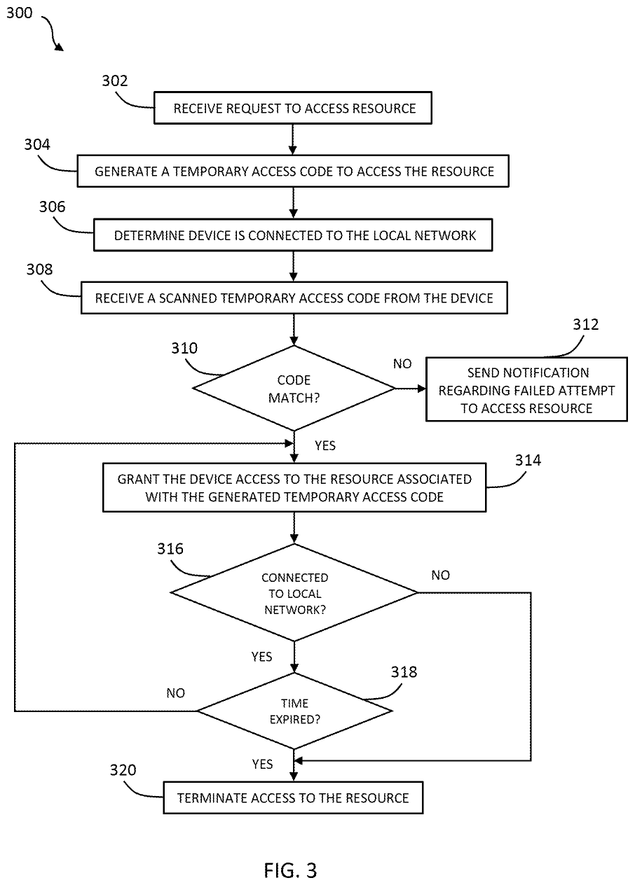

FIG. 2 depicts a process flow of a temporary access program granting access to various resources to two client devices, in accordance with an embodiment of the present invention. In this embodiment, local area network 202 provides a communication channel to resource 204, where user device 206 and client devices 208 and 210 can communicate to resources 204 through local area network 202. User device 206 is associated with a user that is authorized to access resources 204 through various credential authentication methods. In one example, a user of user device 206 is an employee of a company that is authorized to access various resources 204 (e.g., databases, servers) through a two-step authentication (e.g., username and password combination with a secondary authentication key). Client devices 208 and 210 are each associated with a user that is not authorized to access resources 204, since the users do not have proper credentials for authentication. The operational steps of temporary access program 300, discussed in further detail with regards to FIG. 3, allow for the users of client devices 208 and 210 to temporarily access resources 204 utilizing a one-time code. In this embodiment, temporary access program 300 receives a request from user device 206 to allow temporary access to one or more of resources for client device 208 and 210. Temporary access program 300 determines that client devices 208 and 210 are connected to local area network 202 and generates a unique temporary access code for each of client devices 208 and 210, where the unique temporary access code provides a single-time access to each of client devices 208 and 210. The unique temporary access code can include a quick response (QR) code, a barcode, a data matrix, an Aztec code, or any other device scannable code. In some embodiments, the temporary access code can be a unique combination of numerical and alphabetical values.

Temporary access program 300 generates and displays the unique temporary access codes on user device 206, wherein a first temporary access code is scannable by client device 208 and a second temporary access code is scannable by client device 210. Client device 208 scans first code 212 and client device 210 scans second code 214 utilizing a respective camera. Temporary access program 300 receives first code 212 from client device 208 and second code 214 from client device 210 and determines whether first code 212 matches the first temporary access code and the second code 214 matches the second temporary access code. In the event temporary access program 300 determines the first code 212 matches the first temporary access code and the second code 214 matches the second temporary access code, temporary access program 300 grants client devices 208 and 210 access to one or more of resources 204, as long as client devices 208 and 210 remain connected to local area network 202 and a time defined session for the temporary access has not expired. In this embodiment, temporary access program 300 generates a unique temporary access code (i.e., first temporary access code and second temporary access code) for each of client device 208 and 210. In other embodiments, temporary access program 300 generates a single unique temporary access code that is a two-time use code for client devices 208 and 210, where a first scan by client device 208 and a second scan by client device 210 represent the two-time usage of the single unique temporary access code. Sample data 216 represents an example of embedded information in the temporary access code for one or more of resources 204 detailing a private key, resources details for the one or more of resources 204 to be accessed by client devices 208 and 210, payload for decryption, and a time limit for the temporary access by client device 208 and 210 to the one or more of resources 204.

FIG. 3 depicts a flowchart of a temporary access program granting access to a specific resource utilizing a temporary access code, in accordance with an embodiment of the present invention.

Temporary access program 300 receives a request to access a resource (302). In this embodiment, temporary access program 300 receives the request to access the resource from a user device associated with a user authorized to access the resource, where the user device is accessing the resource via a local network. Since the user previously provided proper authentication credentials to access the resource and a current session for accessing the resource is active via the local network, temporary access program 300 allows another user, such as, a client with a client device to access the resource for a predetermined amount of time or until the current session is terminated by the user. Temporary access program 300 provides remote access via the current session for only the specific resource (e.g., database, server) for which the request is received. Temporary access program 300 can identify the resource to be temporarily accessed by a client device based on the current session that is active for accessing the resource on the user device. Alternatively, temporary access program 300 can query the user device to identify a specific resource to grant temporary access to and can verify whether or not there is a current session that is active for the specific resource on the user device. In one example, temporary access program 300 receives a request to access a resource from a user device associated with an employee of a company, where the employee previously provided credentials to access a database and a current session for accessing the database is active. The request can identify a number of client devices for which temporary access program 300 is to generate a temporary access code. The request can also identify a device name and/or identification number of each client device for which temporary access program 300 is to generate a temporary access code.

Temporary access program 300 generate a temporary access code to access the resource (304). Temporary access program 300 generates the temporary access code to access the specific resource, where the temporary access code is scannable by a client device associated with a client attempting to the specific resource. The temporary access code includes metadata identifying the specific resource, a time limit for accessing the specific resource, and a private key for accessing. In this embodiment, the temporary access code is a one-time use code, where temporary access program 300 generates a different temporary access code even if the same specific resource is being accessed during the current session by the same client device. Since the temporary access code includes a time limit (e.g., one hour), temporary access program 300 can regenerate a new temporary access code for the same client device if needed for the current session where the user device is actively accessing the specific resource. Temporary access program 300 can encrypt a payload within the temporary access code, thus requiring a decryption of the payload prior to establishing the temporary remote access to the specific resource. As previously discussed, the temporary access code can be a quick response (QR) code, a barcode, a data matrix, an Aztec code, or any other device scannable code. In some embodiments, the temporary access code can be a unique combination of numerical and alphabetical values, where the client device can capture (i.e., scan) the unique combination of numerical and alphabetical values and temporary access program 300 can receive the unique combination of numerical and alphabetical values as the scanned temporary access code. Temporary access program 300 generates and displays the temporary access code in a user interface on the user device with the current session that is active for accessing the resource.

Temporary access program 300 determines the device is connected to the local network (306). As discussed above, the local network represents a communication network through which the user device is accessing the resource. The local network can represent a local wireless internet connection in an office, where the user device is utilizing the local wireless internet connection in the office to access the resource. Temporary access program 300 determines the client device is connected to the same local network as the user device with current session that is accessing the resource. Temporary access program 300 ensures the client device attempting to access the resource that the user device is currently accessing and providing accessing to, is on the same local network.

Temporary access program 300 receives a scanned temporary access code from the device (308). In this embodiment, a user of client device approaches the user device and scans a generated temporary access code for a specific resource utilizing a camera on the client device, where temporary access program 300 displays the generated temporary access code in the user interface of the user device with the current session. Subsequent to the client device scanning the generated temporary access code for the specific resource, the client device sends the scanned temporary access code to temporary access program 300. Temporary access program 300 receives the scan of the temporary access code from the client device and determines if the scanned temporary access code matches the generated temporary access code for the specific resource being accessed by the user device.

Temporary access program 300 determines whether the scanned temporary access code matches the generated temporary access code for the resource (decision 310). In the event temporary access program 300 determines the scanned temporary access code does not match the generated temporary access code for the resource (“no” branch, decision 310), temporary access program 300 sends a notification regarding a failed attempt to access the resource (312). In the event temporary access program 300 determines the scanned temporary access code does match the generated temporary access code for the resource (“yes” branch, decision 310), temporary access program 300 grants the device access to the resource associated with the generated temporary access code (314).

Temporary access program 300 sends a notification regarding a failed attempt to access the resource (312). In this embodiment, temporary access program 300 determines the scanned temporary access code by the client device does not match the generated temporary access code for a specific resource being accessed during a current session by the user device. Temporary access program 300 sends, to the user device, the notification regarding the failed attempt by the client device to access the specific resource. Temporary access program 300 can further include additional information in the notification indicating a cause for the failed attempt. In one example, temporary access program 300 receives a scanned temporary access code from the client device and determines that the scanned temporary access code matched an expired temporary access code for the specific resource. Temporary access program 300 determines the expired temporary access code is no longer active due to a time value being exceeded between the generation of the temporary access code and the receiving of the scanned temporary access code from the client device. Therefore, temporary access program 300 sends a notification to the user device regarding the failed attempt by the client device indicating the received scanned temporary access code from the client device expired. Temporary access program 300 can further include a selectable option in the notification to generate a new temporary access code for the client device attempting to access the resource.

In another example, temporary access program 300 receives a scanned temporary access code from the client device and determines that the scanned temporary access code matches a previously utilized temporary access code for the specific resource, where another client device utilized the one-time use generated temporary access code to access the specific resource. Temporary access program 300 sends a notification to the user device regarding the failed attempt by the client device indicating the received scanned temporary access code from the client device was previously utilized by another client device to access the resource. Temporary access program 300 can further include a selectable option in the notification to cease the current access session to the resource on the user device, if the user believes a malicious device scanned proved a temporary access code that matched the generated temporary access code. Temporary access program 300 can end the current session for accessing the resource by logging out the user from the user device or can temporarily disconnect from the local network connection to end the current session for accessing the resource.

Temporary access program 300 grants the device access to the resource associated with the generated temporary access code (314). In this embodiment, temporary access program 300 grants the client device access to the resource associated with the generated temporary access code by activating a remote access session for a predetermined amount of time or until the user of the user device with the current access session to the resource ceases. Temporary access program 300 can open a browser window in a user interface on the client device to access the resource that is currently being accessed by the user device. In one example, temporary access program 300 receives a request to access a resource from a user device associated with an employee of a company, where the employee previously provided credentials to access a database and a current session for accessing the database is active. Temporary access program 300 generates a temporary access code for a client visiting onsite to access the database during the current session of the user device associated with the employee and determines a client device and the user device are connected to the same local network onsite. Temporary access program 300 receives a scanned temporary access code from the client device associated with the client and determines the scanned temporary access code matches the generated temporary access code to access the database during the current session of the user device associated with the employee. Temporary access program 300 grants the client access to the database associated with the generated temporary access code by opening a bowser window in a user interface on the client device with the contents of the database.

In another example, temporary access program 300 receives a request to access a resource from a user device associated with a subscriber of a newsletter, where the subscriber previously provided credentials to access a research paper and a current session for accessing the research paper is active. Temporary access program 300 generates a temporary access code for a non-subscriber to access the research paper during the current session of the user device associated with the subscriber and determines another device (i.e., client device) and the user device are connected to the same local network at a library on a university campus. Temporary access program 300 receives a scanned temporary access code from the other device associated with the non-subscriber and determines the scanned temporary access code matches the generated temporary access code to access the research paper during the current session of the user device associated with the subscriber. Temporary access program 300 grants the non-subscriber access to the newsletter associated with the generated temporary access code by opening a bowser window in a user interface on the other device with the contents of the research paper. In one embodiment, temporary access program 300 truncates portions of the content of the resources to hide confidential information (e.g., addressees, birthdates). In another embodiment, temporary access program 300 allows the user device to provide remote access to a resource a set number of times within a predetermined amount of time (e.g., 10 times a month).

Temporary access program 300 determines whether the device is connected to the local network (decision 316). In the event temporary access program 300 determines the device is still connected to the local network (“yes” branch, decision 316), temporary access program 300 determines whether the time expired for the generated temporary access code (decision 318). In the event temporary access program 300 determines the device is no longer connected to the local network (“no” branch, decision 316), temporary access program 300 terminates access to the resources (320). To address any potential malicious activity, temporary access program 300 can continuously monitor the local network and/or the user device and the client device to ensure the user device and the client device are connected to the same local network. This allows for the user of the user device to monitor interactions between the client device the resource being accessed through the remote access to ensure no malicious acts are performed by the client device.

Temporary access program 300 determines whether the time expired for the generated temporary access code (decision 318). In the event temporary access program 300 determines the time has expired for the generated temporary access code (“yes” branch, decision 318), temporary access program 300 terminates access to the resources (320). In the event temporary access program 300 determines the time has not expired for the generated temporary access code (“no” branch, decision 318), temporary access program 300 reverts to granting the device access to the resource associated with the generated temporary access code (314). To further address any potential malicious activity, temporary access program 300 can continuously monitor a duration between the generation of the temporary access code to the resource and a current time, to ensure that the pre-determined amount of time (e.g., one hour) to access the resource has not been exceeded by the client device (i.e., time expired). Alternatively, temporary access program 300 can continuously monitor a duration between granting the client device access to the resource and a current time, to ensure that the pre-determined amount of time to access the resource has not been exceeded by the client device. This allows for the remote access to time out and for temporary access program 300 to terminate access to the resource to reduce the risk of potential malicious activity.

Temporary access program 300 terminates access to the resource (320). In one embodiment, temporary access program 300 terminates access to the resource by closing the browser window in the user interface of the client device that was providing access to the resource. In another embodiment, temporary access program 300 terminates access to the resource by displaying an overlay over the browser window and providing a notification requesting the client scan a new temporary access code to continue accessing the resource.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
generating a temporary access code to access a resource;
determining a client device is connected to a local network, wherein a user device is authorized to access the resource and is in a current session actively accessing the resource on the local network;
receiving, from the client device, a scanned temporary access code; and
responsive to determining the scanned temporary access code matches the temporary access code to access the resource, granting the client device access to the resource.

2. The computer-implemented method of claim 1, further comprising:
displaying, in a user interface on the user device, the temporary access code to access the resource, wherein the temporary access code displayed in the user interface of the user device is scannable by the client device.

3. The computer-implemented method of claim 1, wherein granting the client device the access to the resource further comprises:
opening, in a user interface on the client device, a browser window with the access to the resource.

4. The computer-implemented method of claim 3, further comprising:
subsequent to granting the client device the access to the resource, determining whether the client device is connected to the local network; and
responsive to determining the client device is no longer connected to the local network, terminating the access to the resource.

5. The computer-implemented method of claim 4, wherein terminating the access to the resource further comprises:
closing, in the user interface on the client device, the browser window with the access to the resource.

6. The computer-implemented method of claim 3, further comprising:
subsequent to granting the client device the access to the resource, determining a time expired for the generated temporary access code; and
responsive to determining the time has expired for the generated temporary access code, terminating the access to the resource.

7. The computer-implemented method of claim 6, wherein terminating the access to the resource further comprises:
displaying, in the user interface on the client device, an overlay over the browser window with the access to the resource; and
providing a notification requesting the client device scan a new temporary access code to continue accessing the resource.

8. A computer program product comprising:
one or more computer-readable storage media;
program instructions, stored on at least one of the one or more storage media, to generate a temporary access code to access a resource;
program instructions, stored on at least one of the one or more storage media, to determine a client device is connected to a local network, wherein a user device is authorized to access the resource and is in a current session actively accessing the resource on the local network;
program instructions, stored on at least one of the one or more storage media, to receive, from the client device, a scanned temporary access code; and
program instructions, stored on at least one of the one or more storage media, responsive to determining the scanned temporary access code matches the temporary access code to access the resource, to grant the client device access to the resource.

9. The computer program product of claim 8, further comprising:
program instructions, stored on at least one of the one or more storage media, to display, in a user interface on the user device, the temporary access code to access the resource, wherein the temporary access code displayed in the user interface of the user device is scannable by the client device.

10. The computer program product of claim 8, wherein program instructions, stored on at least one of the one or more storage media, to grant the client device the access to the resource further comprises:
program instructions, stored on at least one of the one or more storage media, to open, in a user interface on the client device, a browser window with the access to the resource.

11. The computer program product of claim 10, further comprising:
program instructions, stored on at least one of the one or more storage media, subsequent to granting the client device the access to the resource, to determine whether the client device is connected to the local network; and
program instructions, stored on at least one of the one or more storage media, responsive to determining the client device is no longer connected to the local network, to terminate the access to the resource.

12. The computer program product of claim 11, wherein program instructions, stored on at least one of the one or more storage media, to terminate the access to the resource further comprises:
program instructions, stored on at least one of the one or more storage media, to close, in the user interface on the client device, the browser window with the access to the resource.

13. The computer program product of claim 10, further comprising:
program instructions, stored on at least one of the one or more storage media, subsequent to granting the client device the access to the resource, to determine a time expired for the generated temporary access code; and
program instructions, stored on at least one of the one or more storage media, responsive to determining the time has expired for the generated temporary access code, to terminate the access to the resource.

14. The computer program product of claim 13, wherein program instructions, stored on at least one of the one or more storage media, to terminate access to the resource further comprises:
program instructions, stored on at least one of the one or more storage media, to display, in the user interface on the client device, an overlay over the browser window with the access to the resource; and
program instructions, stored on at least one of the one or more storage media, to provide a notification requesting the client device scan a new temporary access code to continue accessing the resource.

15. A computer system comprising:
one or more processors, one or more computer-readable memories and one or more computer-readable storage media;
program instructions, stored on at least one of the one or more storage media for execution by at least one of the one or more processors via at least one of the one or more memories, to generate a temporary access code to access a resource;
program instructions, stored on at least one of the one or more storage media for execution by at least one of the one or more processors via at least one of the one or more memories, to determine a client device is connected to a local network, wherein a user device is authorized to access the resource and is in a current session actively accessing the resource on the local network;
program instructions, stored on at least one of the one or more storage media for execution by at least one of the one or more processors via at least one of the one or more memories, to receive, from the client device, a scanned temporary access code; and
program instructions, stored on at least one of the one or more storage media for execution by at least one of the one or more processors via at least one of the one or more memories, responsive to determining the scanned temporary access code matches the temporary access code to access the resource, to grant the client device access to the resource.

16. The computer system of claim 15, further comprising:
program instructions, stored on at least one of the one or more storage media for execution by at least one of the one or more processors via at least one of the one or more memories, to display, in a user interface on the user device, the temporary access code to access the resource, wherein the temporary access code displayed in the user interface of the user device is scannable by the client device.

17. The computer system of claim 15, wherein program instructions, stored on at least one of the one or more storage media for execution by at least one of the one or more processors via at least one of the one or more memories, to grant the client device the access to the resource, further comprises:
program instructions, stored on at least one of the one or more storage media for execution by at least one of the one or more processors via at least one of the one or more memories, to open, in a user interface on the client device, a browser window with the access to the resource.

18. The computer program product of claim 17, further comprising:
program instructions, stored on at least one of the one or more storage media for execution by at least one of the one or more processors via at least one of the one or more memories, subsequent to granting the client device the access to the resource, to determine whether the client device is connected to the local network; and
program instructions, stored on at least one of the one or more storage media for execution by at least one of the one or more processors via at least one of the one or more memories, responsive to determining the client device is no longer connected to the local network, to terminate the access to the resource.

19. The computer system of claim 18, wherein program instructions, stored on at least one of the one or more storage media for execution by at least one of the one or more processors via at least one of the one or more memories, to terminate the access to the resource further comprises:
program instructions, stored on at least one of the one or more storage media for execution by at least one of the one or more processors via at least one of the one or more memories, to close, in the user interface on the client device, the browser window with the access to the resource.

20. The computer system of claim 17, further comprising:
program instructions, stored on at least one of the one or more storage media for execution by at least one of the one or more processors via at least one of the one or more memories, subsequent to granting the client device the access to the resource, to determine a time expired for the generated temporary access code; and
program instructions, stored on at least one of the one or more storage media for execution by at least one of the one or more processors via at least one of the one or more memories, responsive to determining the time has expired for the generated temporary access code, to terminate the access to the resource.
